(19) United States
(12) Patent Application Publication
(10) Pub. No.: US 2026/0358136 A1
(43) Pub. Date: Nov. 12, 2026

(54) UPDATING A MAP FOR SLAM

(71) Applicant: Telefonaktiebolaget LM Ericsson (publ), Stockholm (SE)

(72) Inventors: Roberto CASTRO SUNDIN, Stockholm (SE); David UMSONST, Stockholm (SE); Magnus LINDHÉ, Stockholm (SE); Fernando dos Santos BARBOSA, Stockholm (SE); Clarav GOMEZ BLAZQUEZ, Stockholm (SE); Mina FERIZBEGOVIC, Stockholm (SE)

(73) Assignee: Telefonaktiebolaget LM Ericsson (publ), Stockholm (SE)

(21) Appl. No.: 19/470,422

(22) PCT Filed: Mar. 27, 2023
(86) PCT No.: PCT/EP2023/057775

§ 371 Date: Sep. 29, 2025

(51) Int. Cl. G01C 21/00

(52) U.S. Cl. CPC G01C 21/3804

(57) ABSTRACT

It is provided a method for updating a map for simultaneous localisation and mapping, SLAM. The method is performed by a server. The method comprises: receiving first measurements from a mobile device, the first measurements being collected using at least one sensor of the mobile device; determining that a new reduced local map is to be computed for the mobile device; predicting a position of the mobile device, corresponding to where the mobile device is likely to be located at a time when a future reduced local map is available in the mobile device; computing a reduced local map for the mobile device based on the predicted position, the reduced local map being a subset of a global map, wherein the global map is in the form of a graph comprising vertices and edges; and sending, to the mobile device, the computed reduced local map.

### TECHNICAL FIELD

The present disclosure relates to the field of simultaneous localisation and mapping (SLAM), and in particular to updating a map for SLAM.

### BACKGROUND

Localisation and mapping are used for many types of mobile devices, such as for extended reality (XR) devices, encompassing augmented reality (AR) and virtual reality (VR) devices, as well as self-driving cars, unmanned aerial vehicles, robots, etc. Localisation is the process of determining the pose of a mobile device/object in space, where pose is defined as the concatenation of position and orientation. Mapping is the process of mapping the real world in a data structure.

The localisation and mapping for mobile devices can be enhanced by merging structural (visual and/or depth-related) information from environment sensors e.g. cameras, lidar, etc. and motion information from Inertial Measurement Units (IMUs). In this way, the mobile device is able to acquire six degrees of freedom movements of the mobile device (rotation and translation).

The localisation is based on a map comprising representations of the physical space. The representation can be the result of processing of the raw structural data from one or more mobile devices, each comprising one or more environment sensors. The representation can e.g. comprise segments representing sections of the physical space and/or features representing distinguishable geometric structures in the physical space. The localisation is performed when captured data from the environment sensor(s) is processed and compared with the data in the map. When a match is found, this results in a pose of the mobile device being determined.

When both localisation and mapping are combined, i.e. learning an area while keeping track of a pose of a mobile device, this is known as Localisation and Mapping (LM), or Simultaneous Localisation and Mapping (SLAM).

Modern SLAM systems can comprise two interconnected parts, a front-end and a back-end. The front-end processes the measurements taken from the environment. This processing can comprise a feature extraction module, which extracts relevant features from the environment measurements, and a data association module, which brings the measurements in relationship to each other. The back-end uses the processed measurements to perform inference via maximum a posteriori (MAP) estimation. The current state-of-the-art to perform the MAP estimation is a graph-SLAM approach, where the map is abstracted into a mathematical graph. Therefore, the terms map and graph are interchangeable in this document.

One component in SLAM is the construction and repetitive update of the map. A challenge arises from the fact that mobile devices can often be resource-constrained embedded devices, which reduces the extent of processing that can be performed for the localisation and/or the map processing. A server can then generate an updated local map for use in the mobile device.

### SUMMARY

One object is to make improve the relevance of server updates to a local map for use in a mobile device.

According to a first aspect, it is provided a method for updating a map for simultaneous localisation and mapping, SLAM. The method is performed by a server. The method comprises: receiving first measurements from a mobile device, the first measurements being collected using at least one sensor of the mobile device; determining that a new reduced local map is to be computed for the mobile device; predicting a position of the mobile device, corresponding to where the mobile device is likely to be located at a time when a future reduced local map is available in the mobile device; computing a reduced local map for the mobile device based on the predicted position, the reduced local map being a subset of a global map, wherein the global map is in the form of a graph comprising vertices and edges; and sending, to the mobile device, the computed reduced local map.

The method may comprise: obtaining auxiliary data for predicting the position of the mobile device. In this case, the predicting a position comprises predicting the position of the mobile device based on the auxiliary data.

The auxiliary data may comprise a current position of the mobile device.

The auxiliary data may comprise a current movement indicator of the mobile device.

The auxiliary data may comprise an indication of the time it takes for the server to compute the reduced local map.

The auxiliary data may comprise an indication of the time it takes for the server to send the reduced local map to the mobile device.

The method may further comprise: estimating a field of view of the mobile device. In this case, the computing the reduced local map comprises computing the reduced local map for the mobile device such that vertices of the global map that are within the estimated field of view are more likely to form part of the reduced local map than vertices outside the estimated field of view.

The computing the reduced local map may comprise including all vertices of the global map that are within the estimated field of view and that are within a distance threshold from the mobile device.

The predicting a position of the mobile device and computing a reduced local map may be performed a plurality of times, respectively, for a plurality of scenarios, resulting in a plurality of reduced local maps.

The sending the computed reduced local map may comprise sending the plurality of reduced local maps.

The method may further comprise: receiving, after the receiving the first measurements, second measurements from the mobile device indicating an updated pose of the mobile device, the updated pose being associated with a later time than a pose corresponding to the first measurements; and discarding at least one of the plurality of reduced local maps based on the updated pose.

The measurements may be based on at least one of inertial measurements, LIDAR measurements, two-dimensional images, three-dimensional images and radar measurements.

Each vertex may represent a pose of the mobile device or a feature observed by the mobile device.

According to a second aspect, it is provided a server for updating a map for simultaneous localisation and mapping, SLAM. The server comprises: a processor; and a memory storing instructions that, when executed by the processor, cause the server to: receive first measurements from a mobile device, the first measurements being collected using at least one sensor of the mobile device; determine that a new reduced local map is to be computed for the mobile device predict a position of the mobile device, corresponding to where the mobile device is likely to be located at a time when a future reduced local map is available in the mobile device; compute a reduced local map for the mobile device based on the predicted position, the reduced local map being a subset of a global map, wherein the global map is in the form of a graph comprising vertices and edges; and send, to the mobile device, the computed reduced local map.

The server may further comprise instructions that, when executed by the processor, cause the server to: obtain auxiliary data for predicting the position of the mobile device. In this case, the instructions to predict a position comprise instructions that, when executed by the processor, cause the server to predict the position of the mobile device based on the auxiliary data.

The auxiliary data may comprise a current position of the mobile device.

The auxiliary data may comprise a current movement indicator of the mobile device.

The auxiliary data may comprise an indication of the time it takes for the server to compute the reduced local map.

The auxiliary data may comprise an indication of the time it takes for the server to send the reduced local map to the mobile device.

The server may further comprise instructions that, when executed by the processor, cause the server to: estimate a field of view of the mobile device. In this case, the instructions to compute the reduced local map comprise instructions that, when executed by the processor, cause the server to compute the reduced local map for the mobile device such that vertices of the global map that are within the estimated field of view are more likely to form part of the reduced local map than vertices outside the estimated field of view.

The instructions to compute the reduced local map may comprise instructions that, when executed by the processor, cause the server to include all vertices of the global map that are within the estimated field of view and that are within a distance threshold from the mobile device.

The server may further comprise instructions that, when executed by the processor, cause the server to execute the instructions to predict a position of the mobile device and compute a reduced local map a plurality of times, respectively, for a plurality of scenarios, resulting in a plurality of reduced local maps.

The instructions to send the computed reduced local map may comprise instructions that, when executed by the processor, cause the server to send the plurality of reduced local maps.

The server may further comprise instructions that, when executed by the processor, cause the server to: receive, after the receiving the first measurements, second measurements from the mobile device indicating an updated pose of the mobile device, the updated pose being associated with a later time than a pose corresponding to the first measurements; and discard at least one of the plurality of reduced local maps based on the updated pose.

The measurements may be based on at least one of inertial measurements, LIDAR measurements, two-dimensional images, three-dimensional images and radar measurements.

Each vertex may represent a pose of the mobile or a feature observed by the mobile device.

According to a third aspect, it is provided a computer program for updating a map for simultaneous localisation and mapping, SLAM. The computer program comprises computer program code which, when executed on a server causes the server to: receive first measurements from a mobile device, the first measurements being collected using at least one sensor of the mobile device; determine that a new reduced local map is to be computed for the mobile device; predict a position of the mobile device, corresponding to where the mobile device is likely to be located at a time when a future reduced local map is available in the mobile device; compute a reduced local map for the mobile device based on the predicted position, the reduced local map being a subset of a global map, wherein the global map is in the form of a graph comprising vertices and edges; and send, to the mobile device, the computed reduced local map.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating a system for updating a map for SLAM;

FIG. 3 is a schematic diagram illustrating another environment in which embodiments presented herein can be applied;

FIGS. 4A-B are swimlane diagrams illustrating embodiments of methods for updating a map for SLAM;

FIG. 5 is a schematic diagram illustrating components of the server of FIG. 1 and FIG. 2 according to one embodiment;

FIG. 6 is a schematic diagram showing functional modules of the server of FIG. 1 and FIG. 2 according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, an improved generation of local maps for use in mobile devices is achieved, where there is a local map in the mobile device and a global map in a server. According to embodiments presented herein, the server predicts a future position of the mobile device, and computes the reduced local map based on this prediction. This results in a reduced local map with improved relevance for the mobile device.

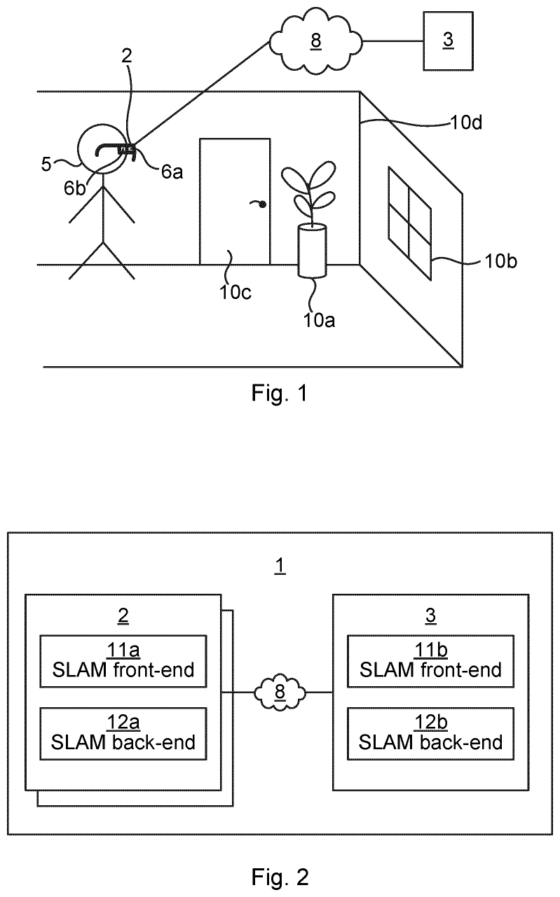

FIG. 1 is a schematic diagram illustrating an environment in which embodiments presented herein can be applied. In the example illustrated in FIG. 1, there is a user 5 with a mobile device 2. The mobile device 2 comprises at least one sensor. In this example, there is a first sensor 6a in the form of a camera and a second sensor 6b in the form of an Inertial Measurement Unit (IMU). The IMU can e.g. comprise an accelerometer and a gyro. Other examples of possible sensors are a LIDAR sensor, a radar sensor, stereo camera, structure from motion, etc. In order to generate a map, the mobile device needs at least one exteroceptive sensor (LIDAR, RGBD camera, radar, etc.), but to improve the accuracy of the measurements, this should be combined with a proprioceptive sensor such as, e.g. an IMU, or optical encoders. The mobile device 2 can be a wearable device, such as smart glasses, head-mounted display (HMD), or the mobile device 2 can be a smartphone, car, etc. The mobile device 2 can also be provided as a device that does not require user interaction, e.g. in the form of a self-driving vehicle or robot.

One or more servers 3 are provided with ability to communicate with the mobile device 2, as well as other mobile devices (not shown). The communication occurs over a communication network 8, e.g. based on Internet Protocol traffic over any one or more wireless or wired-based technology, such as a cellular network, any of the IEEE 802.11x standards (also known as Wi-Fi), using Bluetooth or Bluetooth Low Energy (BLE), ZigBee, Ethernet, optical communication, etc. The cellular communication network can e.g. comply with any one or a combination of sixth generation (6G) networks, next generation (NG) mobile networks (fifth generation, 5G), LTE (Long Term Evolution), UMTS (Universal Mobile Telecommunications System) utilising W-CDMA (Wideband Code Division Multiplex), CDMA2000 (Code Division Multiple Access 2000), or any other currently known or future wireless network, as long as the principles described hereinafter are applicable.

The server 3 can be implemented as a so-called edge server, implying that it is topologically close to the mobile device 2, which reduces latency and increases responsiveness. Alternatively, the server 3 is implemented in a more central location topologically, which allows the server 3 to serve a larger number of mobile devices 2 in different areas.

Collectively, the server 3 and one or more mobile devices 2 form a system, that is used for updating a local map for use by the mobile device 2, according to procedures that are described in more detail below. The local map is stored within the mobile device 2 and covers an area or a set of features that can be close to the mobile device 2.

In the environment around the user 5, there are a number of visually distinguishable features, hereinafter referred to visual features 10a-d, e.g. a first visual feature 10a in the form of a plant, a second visual feature 10b in the form of a window, a third visual feature 10c in the form of a door and a fourth visual feature 10d in the form of a corner in the room. There may be many more (or fewer) visual features depending on the location of the user 5 and feature detection capabilities of the mobile device 2.

The mobile device 2 is capable of performing localisation as well as mapping using its sensor(s) based on SLAM. By performing localisation and mapping, the mobile device is able to calculate its pose with respect to the physical space. Pose is a term that, in the present context, includes both position and orientation.

The mobile device 2 stores a local map. Map processing performed in the mobile device 2 results in updates to the local map.

The server 3 stores a global map, also sometimes referred to as a central map. It is to be noted that the global map is global only within the particular implementation. In other words, for multiple implementations or systems, there are respective global maps. Hence, there is not only one global map in the world; there are multiple global maps. Since the server 3 is less restricted in terms of processing power and storage, the global map can be significantly larger than the local map. The local map can be based on a subset of the global map, covering an area or a set of features covered by the global map. Hence, the global map on the server is richer than the local map, unless the mobile device is in an area not yet covered by the global map, in which case the local map and the global map can, at least initially, develop synchronously.

Hence, the local map is a map which can contain information related to the immediate vicinity of the mobile device. A global map is a map that is built as an aggregation of all measurements taken by one or more mobile devices. The global map thus comprises information related to an environment which can be acquired over a longer period of time and can also contain local maps acquired by more than one mobile device 2 and for multiple different physical locations. For example, if the mobile device is used in a building, then the global map could have information about the whole building. The global map could contain the different floor plans with the rooms that the mobile device has already explored. In this example, the local map would have only information of one of the floors in the building or even only a section or a room where the mobile device is currently located. With reference to FIG. 1, what is visible in FIG. 1 is the local map, while the part of the room/house that is not visible, e.g. the part to the left of the user 5 or on the other side of the door 10c, can form part of the global map. It is to be noted that another global map could be applicable if the user leaves the building, or the global map could extend also outside the building.

FIG. 2 is a schematic diagram illustrating a system 1 for updating a map for SLAM. The system 1 comprises a server 3 and at least one mobile device 2.

As explained above, modern SLAM systems can comprise of two interconnected parts, a front-end and a back-end. The mobile device(s) 2 comprises a mobile SLAM front-end 11a and a mobile SLAM back-end 12a. The server 3 comprises a server SLAM front-end 11b and a server SLAM back-end 12b.

Similar processing occurs in both front-ends 11a, 11b and similar processing occurs in both back-ends 12a, 12b. The processing will herein only be distinguished between mobile device 2 and server 3 where this makes a difference. The front-end 11a, 11b processes the measurements taken from the environment. This processing can comprise a feature extraction module, which extract relevant features from the environment measurements, and a data association module, which brings the measurements in relationship to each other. These relationships can be translated into relative translations and rotations of the mobile device. The back-end 12a, 12b uses the processed measurements to perform inference via maximum a posteriori estimation. The back-end 12a, 12b can optionally perform any other suitable inference procedure.

In the back-end 12a, 12b, the processed measurements are used to create a graph where each vertex in the graph represents a feature-based landmark observed in the environment, or a pose of the mobile device. An edge between vertices in the graph encodes how the vertices relate to each other, e.g. how far a certain landmark is from a certain pose. The data association module in the front-end 11a, 11b can be responsible for creating the edges between the vertices in the graph.

The graph reflects loop closures that have been added to the graph as edges between (possibly non-consecutive) vertices, in which case non-consecutive vertices of the graph are connected with an edge. This implies the mobile device is currently in a location in its environment that it has visited before and, therefore, recognizes. Loop-closures help mitigate the effect of accumulated errors in the sensor-based odometry (sensors such as LiDAR, IMU, Visual-Inertial). In order to detect loop-closures, the mobile device accesses previous measurements. Hence, the greater area that a device explores, the more data it gathers, such that the limitations of a resource-constrained mobile device 2 can be reached quickly, especially for lightweight devices, such as AR glasses. In the following, the focus is on the back-end 12a, 12b of the SLAM algorithm since the front-end 11a, 11b varies significantly dependent on the sensors used on the mobile device 2.

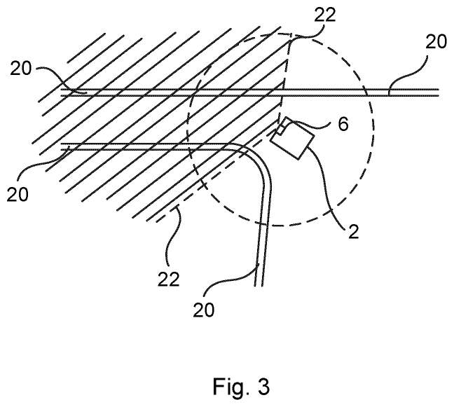

FIG. 3 is a schematic diagram illustrating another environment in which embodiments presented herein can be applied. A mobile device 2, e.g. forming part of a vehicle, is moving in a street environment. In this example, there are physical structures 20 delimiting the streets, e.g. in the form of buildings and/or kerb. A range 21 defines a region within a distance of the mobile device 2. A field of view (FOV) 22 is defined as an angular range within which the mobile device 2, or more specifically a (visual) sensor 6 of the mobile device 2, can observe visual features of its environment. Within the top view of FIG. 3, there are multiple nodes (not shown) being visual features that form part of the global map, that represent points on the physical structures 20.

There are several embodiments for defining what nodes should form part of a reduced local map, the computation of which is described in more detail below.

In one embodiment, only spatial heuristics are applied, whereby only nodes within the range 21 are included in the reduced local map. This is a reasonable selection of nodes, since nodes that are far away are unlikely to be observable by the mobile device 2.

In one embodiment, the FOV heuristics are applied. In this case, only nodes that are within the FOV 22 are included in the reduced local map. Hence, nodes that are outside the FOV 22 are disregarded for the reduced local map, since these may not be observable by the mobile device. In one embodiment, the FOV that is used for the node selection includes a margin (e.g. +−x degrees) from the FOV of the mobile device.

In one embodiment, spatial heuristics are combined with FOV heuristics. In this case, only nodes that are both within the range 21 and within the FOV 22 are included in the reduced local map.

Using the FOV heuristic, we put focus on the nodes in front of the mobile device's predicted pose, for which there is a high likelihood of loop closure in the near future. If the FOV does not contain N nodes that are to form part of the reduced local map, we utilize all FOV nodes and fill up with the spatially closest nodes (not in FOV). Note that, in order for the mobile device to merge the reduced local maps with its new measurements, the node corresponding to the time when the map reduction was triggered, is selected as part of the N nodes. Once the N nodes have been selected, the server can determine the reduced local map, for example, via marginalization as explained in more detail below.

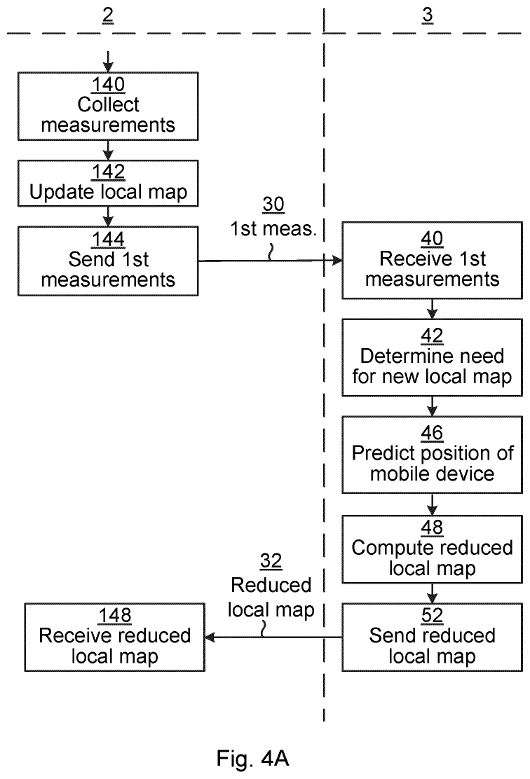

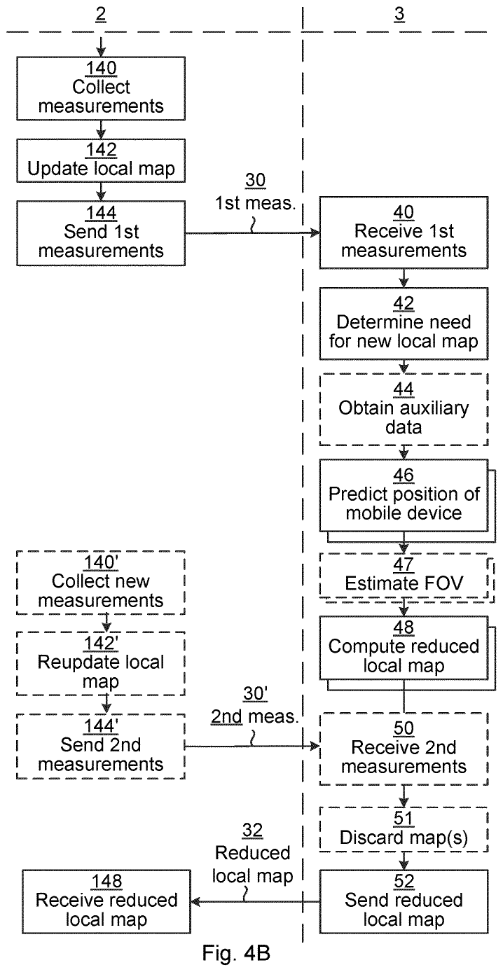

FIGS. 4A-B are swimlane diagrams illustrating embodiments of methods for updating a map for SLAM. The swimlane diagrams can be considered to comprise a flow chart for methods in the mobile device 2 on the left and a flow chart for methods in the server 3 on the right. Communication between the mobile device 2 and the server 3 is also shown. On an overview level, the mobile device 2 observing the environment utilizes the server 3 to obtain a reduced local map of the environment. This is done to save computational resources on the mobile device 2 in the form of execution time of the mobile SLAM back-end 12a. First, the swimlane diagram of FIG. 4A will be described.

In a collect measurements step 140, the mobile device 2 collects measurements from the at least one sensor 6a-b. The measurements can e.g. be based on at least one of inertial measurements (e.g. using an IMU), LIDAR measurements, two-dimensional images, three-dimensional images and radar measurements. Hence, the mobile device runs a SLAM algorithm and observes the environment by taking sensor measurements. The measurements and SLAM enable the mobile device to orient itself in its environment and create a map of the environment.

In an update local map step 142, the mobile device 2 updates a local map based on the measurements, wherein the local map is in the form of a graph comprising vertices and edges. Each vertex may represent a pose or a feature observed by the mobile device. Each edge between vertices then represents the relation (e.g. representing translation and/or rotation) between the two vertices.

The processed measurements are incorporated into the local map, ML, in the mobile SLAM back-end 12a and in the global map, MG, in the server SLAM back-end 12b after more processing in the server SLAM front-end 11b. When the mobile device takes a measurement at time step k and adds it to its own map, the size of the map increases. Here, each measurement is considered to add at least one new vertex to the graph representing [symbol] _{L} such that the number of vertices increases by at least one, i.e. N_{L}(k)≥N_{L}(k−1)+1. Similarly, the measurement is also added to the map on the server such that the number of vertices in [symbol] _{G} also increases, i.e. N_{G}(k)≥N_{G}(k−1)+1. The mobile SLAM front-end 11a will, however, not have access to all previous measurements such that it cannot reliably detect loop-closures in its mobile SLAM front-end 11a. Hence, the increase in the number of edges in [symbol] _{L} will be less than, or equal to, the increase in the number of servers in the server's graph [symbol] _{G}, because the server has access to all measurements and can therefore perform loop-closure detection in its server SLAM front-end 11b.

The more measurements the mobile device takes, the more the local map grows, i.e. the number of vertices of the graph representing the map increases. Therefore, the execution time of the graph optimization (GO) in the mobile SLAM back-end 12a, which the mobile device runs to both built a map of the environment and orient itself in the environment, increases as well. The graph optimization can be expressed in the form of a matrix equation. Thereafter, nonlinear least squares algorithms can be used to perform the optimization. There is a relationship between the number of vertices, N_{L}(k), in the local map and the execution time, Tₑ(k), of the GO, that is, Tₑ(k)=ƒ(N_{L}(k),O), where ƒ(⋅) can be an unknown function. The function ƒ(⋅) can be directly proportional to N_{L}(k). Here, O represents other variables that influence the execution time such as the mobile device's computational resources, the current computational load of the mobile device, and/or the sparsity of the graph representing ML.

In a send 1^{st} measurements step 144, the mobile device 2 sends the measurements in the form of 1^{st} measurements 30 to the server 3. Optionally, the measurements are first pre-processed by the mobile SLAM front-end 11a prior to sending.

In a receive 1^{st} measurements step 40, the server 3 receives the first measurements 30 from the mobile device 2. As explained above, the first measurements 30 are collected using at least one sensor 6a-b of the mobile device 2.

On the server side, we will denote the request times with time index j, which is different from the time index of the execution of the GO, k.

In a determine need for new local map step 42, the server 3 determines that a new reduced local map is to be computed for the mobile device 2. There are various embodiments for checking if a reduced local map, [symbol] _{red}, should be calculated.

In one embodiment, the computation of a reduced local map is periodically triggered. The periodicity could be based on time, for example, compute a reduced local map every ten minutes. Another option is that the periodicity could be based on the number of measurements received from the mobile device, e.g. compute a reduced local map for every ten new measurements received from the mobile device. This embodiment is not complex and can be implemented relatively easily on the server 3.

In one embodiment, the server only computes a reduced local map if it requested to do so by the mobile device. The request could, for example, be sent when the mobile device is struggling with the size of its current map. It could also be based on safety aspects. For example, if the mobile device is in an area where there is a lot of moving objects (and therefore a higher risk of collision). the mobile device could be safer if updates are received more often. In this embodiment, the server 3 does not compute a new reduced local map when it is not yet necessary. Hence, computational resources on the server are saved.

In one embodiment, the server uses the current location of the mobile device in the global map and the previous reduced local map to determine if the mobile device is in an area of the previous reduced local map that borders a known area in the global map. If that is the case, the server can decide to calculate a new reduced local map. In this way, the server can exploit knowledge that is not available to the mobile device, i.e. global map information, to determine an appropriate time when to compute a new reduced local map for the mobile device.

In a predict position of mobile device step 46, the server 3 predicts a position of the mobile device 2, corresponding to where the mobile device 2 is likely to be located at a time when a future reduced local map is available in the mobile device 2. In one embodiment, a complete pose, comprising both the position and orientation of the mobile device 2 is predicted here.

In broad terms, we can use a motion model g to get a predicted pose p as p=g(I), where I contains any of information available for the prediction, including potential auxiliary data mentioned below. The motion model could be constructed either beforehand, or be learned during run-time, or a combination of both (e.g. parametric model with parameters set beforehand, but adjusted during run-time). In the case of the mobile device being a robot, we can use actuator commands, and planned trajectories in the motion model. When the mobile device is not a robot, or planned trajectories are not available, tracking methods can be considered, such as for example EKFs (extended Kalman filters) or particle filters.

In a compute reduced local map step 48, the server 3 computes a reduced local map 32 for the mobile device 2 based on the predicted position. The reduced local map is a subset of a global map. As explained above, the global map is in the form of a graph comprising vertices and edges.

Optionally, an estimated field of view of the mobile device 2 is considered, such that the reduced local map 32 is computed to comprise all vertices of the global map that are within the estimated field of view and that are within a distance threshold from the mobile device 2, as illustrated in FIG. 3 and described above. It is to be noted that the FOV heuristics (optionally in combination with spatial heuristics) can be applied to compute a reduced local map without predicting the position of the mobile device 2.

To compute the reduced local map the server uses its global map, [symbol] _{G}, which is based on all measurements taken by the mobile device(s) and have been transmitted to the server.

The reduced local map is based on the global map, [symbol] _{G}. The server uses the predicted position of the mobile device 2 to compute the reduced local map, [symbol] _{red}. The size of the reduced local map is denoted N_{red}(j). To calculate a reduced local map, the server may exploit spatial marginalization, where all measurements except the N_{y} measurements that are spatially closest, or and/or within the FOV, of the predicted position of the mobile device are marginalized. The marginalized parts (vertices and connected edges) of the global map are thus excluded from the reduced local map.

It is to be noted that while a large N_{y} is beneficial for SLAM processing, there is often an upper limit based on the mobile device's computational resources or other constraints.

Other node selection heuristics are also possible. In one embodiment, nodes are prioritised that are in the room that we predict the mobile device to be in by the time the reduced local map is received. By doing so, we can avoid the fallacy of the spatial (and FOV) heuristic in which nodes are selected that are behind a wall and are not visible for the mobile device. Note that the room-based heuristic is combinable with both the spatial and FOV heuristic. That is, we could select “all the nodes in the FOV of the room”, or “all the nodes spatially closest within the room”.

Optionally, the predict position of mobile device step 46 and the compute reduced local map step 48 are performed a plurality of times, respectively, for a plurality of scenarios, resulting in a plurality of reduced local maps 32. Each scenario represents a different predicted pose of the mobile device 2.

In one embodiment, one reduced local map is computed based on one predicted pose and one reduced local map is computed based on the current position of the mobile device 2. In the case, we use a multi-hypothesis tracking algorithm (such as a particle filter), and a reduced local map is calculated based on each hypothesis. Note that this introduces an additional step, where it is decided which reduced local map is to be used by the mobile device-something that can be done either on the server before sending (according to step 51 below), or on the mobile device after having received the multiple reduced local maps. Which map to use could be decided depending on the mobile device's position (e.g. estimated by server or mobile device) at the time of sending/receiving.

It is to be noted that the computations required to calculate Nₘ reduced local maps are not necessarily Nₘ times more than the computations required for a single map. This is due to the fact that many operations are identical in each map reduction; these operations can thus be cached and re-used in all map reductions. Furthermore, if the server has several processor cores and its load is low, calculation of reduced local maps can be parallelized (e.g. the common computations of the reduced local maps can be split over several threads). In addition to that, the increased time for the calculation of several reduced local maps can be taken into account in the offset calculation (see description of auxiliary data below).

In a send reduced local map step 52, the server 3 sends the computed reduced local map(s) 32 to the mobile device 2. When multiple reduced local maps are computed, the sending of the computed reduced local map 32 can comprise sending the plurality of reduced local maps 32. In this case, the mobile device 2 can use the one of the plurality of reduced local maps whose prediction of position is closest to the outcome for the mobile device 2.

In a receive reduced local map step 148, the mobile device 2 receives (from the server 3) the reduced local map(s) 32. In one embodiment, the mobile device 2 replaces the graph in the mobile SLAM back-end 12a representing the local map with the reduced local map, i.e. [symbol] _{L}= [symbol] _{red}, purging the preceding local map. In one embodiment, the mobile device 2 merges the reduced local map 32 with at least one measurement collected after the sending 144 the first measurements to the server 3. In other words, the mobile device 2 combines the reduced local map and new measurements, [symbol] _{new}, which were not available on the server at the time of calculating the reduced local map, into a new local map as [symbol] _{D}←m( [symbol] _{red}, [symbol] _{new}), where m(⋅) is a function that can merge two maps. Since the reduced local map contains the node which represented the mobile device's location at the time of the reduced local map calculation, the merging of the maps is straight-forward.

Looking now to FIG. 4B, in the interest of conciseness, only new or modified steps compared to FIG. 4A will be described.

In an optional obtain auxiliary data step 44, the server 3 obtains auxiliary data for predicting the position of the mobile device. The auxiliary data can be any type of data that can assist in predicting the position of the mobile device 2. When the auxiliary data is available, the predict position of mobile device step 46 comprises predicting the position of the mobile device 2 based on the auxiliary data.

In one embodiment, the auxiliary data comprises a current position of the mobile device 2. Alternatively or additionally, the auxiliary data comprises a current movement indicator of the mobile device 2. Hence, the server obtains data relating to the mobile device. This information could include the position of the mobile device in the global map, an estimate of its velocity and/or acceleration. Alternatively or additionally, the data can include information from another application used by the mobile device and running on the server such as near-future events in an XR game. Another example could be that the mobile device has offloaded its motion planner to the server, such that the server can access the future trajectory planned by the motion planner.

In one embodiment, the auxiliary data comprises an indication of the time it takes for the server 3 to compute the reduced local map 32, which in turn can be based on a current load on the server 3. Alternatively or additionally, the auxiliary data comprises an indication of the time it takes for the server 3 to send the reduced local map 32 to the mobile device 2.

Describing this embodiment in some more detail, the server loads its global map, [symbol] _{G}, and estimates how much time, Tₜₒₜ(j), it would take for the mobile device to receive the new reduced local map. Here, Tₜₒₜ(j) is mostly influenced by the time, T_{c}(j), it takes the server to compute a reduced local map, and the time, Ty, it takes to send the reduced local map from the server to the mobile device. Hence, Tₜₒₜ(j)=T_{c}(j)+Tₙ. To estimate Tₜₒₜ(j), the server uses previous values of the computation time to estimate T_{c}(j) as \hat{T}_{c}(j).

In one embodiment, the estimate of the time to compute the reduced local map \hat{T}_{c}(j) is calculated using a moving average filter according to:

$${\hat{T}}_{c} ( j ) = \frac{1}{{N}_{c}} {\sum }_{l = j - {N}_{c}}^{j - 1} {T}_{c} ( l ) ,$$

where T_{c}(l)=0 if l<0. The moving average filter is simple to implement and can decrease the effect of noise.

In one embodiment, the estimate of the time to compute the reduced local map \hat{T}_{c}(j) is calculated according a moving median filter of length N_{c}:

\hat{T}_{c}(k)=Median(T_{c}(k−N_{c}−1),T_{c}(k−N_{c}), . . . , T_{c}(k−1)),

where T_{c}(i)=0 if i<0 and Median (⋅) calculates the median value of the inputs. The median filter has the advantage of being more robust against outliers than the moving average filter.

In one embodiment, the estimate of the time to compute the reduced local map \hat{T}_{c}(j) is calculated according to an approximation of quantiles from streams, for example, with t-digest or KLL (Karnin-Lang-Liberty) sketch. In this embodiment, we are able to continuously update the quantile estimates of the distribution of T_{c}. This enables us to make probabilistic inferences of the computation time T_{c}(e.g. “the computation time will be in the span X-Y with a 90% probability”).

To estimate Tₙ, the server can, for example, send a ping and use half of the roundtrip time to estimate the one-way time. With the introduction of 5G and 6G networks, the time Tₙ will become very small, such that it could very well be considered negligible.

In one embodiment, the auxiliary data comprises external information. This could be, e.g. environmental information such as a traffic lights, or if the mobile device is transported, for example, in a train, subway, or elevator. This can be used to predict movement in the near future. For instance, if the mobile device is at a red traffic light, or on a train stopping at a station, the mobile device is not expected to move in the next few seconds. Physical cues from the environment can be used, based on knowledge that the mobile device is restricted to take a certain path or be at a certain location at a certain point in time.

In an optional estimate FOV (field of view) step 47, the server 3 estimates a field of view of the mobile device 2, e.g. as described above with reference to FIG. 3.

When the estimated FOV is available, the compute reduced local map step 48 comprises computing the reduced local map 32 for the mobile device 2 such that vertices of the global map that are within the estimated field of view are more likely to form part of the reduced local map than vertices outside the estimated field of view, i.e. applying FOV heuristics, as described above. Using the FOV heuristic instead of the pure spatial heuristics, the mobile device will get more features in its future FOV, which are the most likely to be loop-closed. Having a faster access to these loop closures would typically mean achieving better localization accuracy.

In an optional collect new measurements step 140′, the mobile device 2 collects new measurements in the same manner as in the collect measurements step 140, but at a later point in time.

In an optional reupdate local map step 142′, the mobile device 2 updates the local map again in the same manner as in the update local map step 142, but at a later point in time.

In an optional send 2^{nd} measurements step 144′, the mobile device 2 sends second measurements 30′ to the server 3.

In an optional receive 2^{nd} measurements step 50, the server 3 receives (after the receiving 40 the first measurements 30) the second measurements 30′ from the mobile device 2. The second measurements 30′ indicate an updated pose of the mobile device, the updated pose being associated with a later time than a pose corresponding to the first measurements.

In an optional discard map(s) step 51, when there are multiple reduced local maps that are computed, the server 3 discards at least one of the plurality of reduced local maps based on the updated pose. In other words, the updated pose is exploited in the selection of which reduces local map is most relevant. As an example, the second measurements 30′ can be used by the server to obtain a quick odometry based estimate off the mobile device's current location. This odometry measurement can then be used to determine which motion prediction was the most accurate. The reduced local map based on the most accurate motion prediction is then sent back to the mobile device and the other(s) are discarded.

Using the position prediction of embodiments presented herein improves SLAM performance on the mobile device, resulting in increased likelihood of finding loop closures on the mobile device. Loop closures found on the server are more likely to be usable directly by the mobile device since the device is more likely to hold the nodes involved in the loop closure.

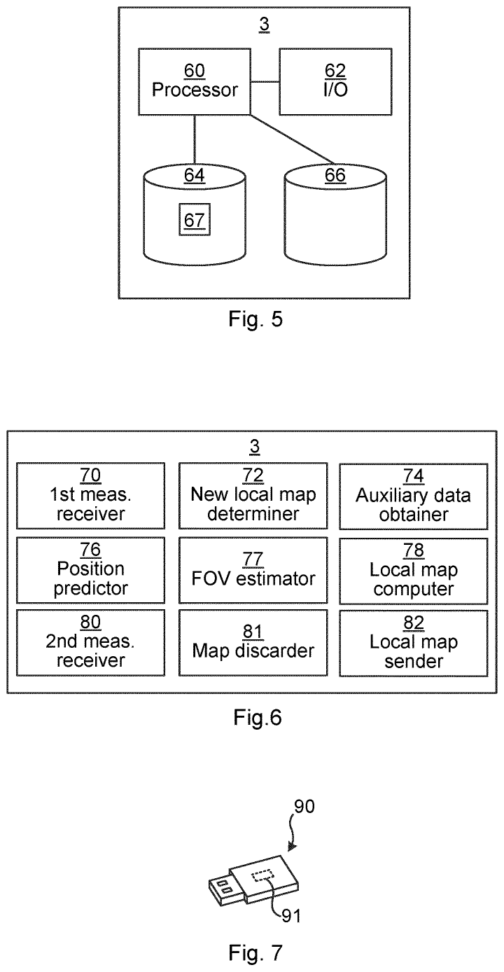

FIG. 5 is a schematic diagram illustrating components of the server 3 of FIG. 1 and FIG. 2 according to one embodiment. A processor 60 is provided using any combination of one or more of a suitable central processing unit (CPU), graphics processing unit (GPU), multiprocessor, microcontroller, digital signal processor (DSP), etc. capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute embodiments of the methods described with reference to FIGS. 4A-B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the server 3 are omitted in order not to obscure the concepts presented herein.

FIG. 6 is a schematic diagram showing functional modules of the server 3 of FIG. 1 and FIG. 2 according to one embodiment. The modules are implemented using software instructions such as a computer program executing in the server 3. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 4A and 4B.

A 1^{st} measurement receiver 70 corresponds to step 40. A new local map determiner 72 corresponds to step 42. An auxiliary data obtainer 74 corresponds to step 44. A position predictor 76 corresponds to step 46. A FOV estimator 77 corresponds to step 47. A local map computer 78 corresponds to step 48. A 2^{nd} measurement receiver 80 corresponds to step 50. A map discarder 81 corresponds to step 51. A local map sender 82 corresponds to step 52.

FIG. 7 shows one example of a computer program product 90 comprising computer readable means 91. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for updating a map for simultaneous localisation and mapping, SLAM, the method being performed by a server, the method comprising:
receiving first measurements from a mobile device, the first measurements being collected using at least one sensor of the mobile device;
determining that a new reduced local map is to be computed for the mobile device;
predicting a position of the mobile device, corresponding to where the mobile device is likely to be located at a time when a future reduced local map is available in the mobile device;
computing a reduced local map for the mobile device based on the predicted position, the reduced local map being a subset of a global map, wherein the global map is in the form of a graph comprising vertices and edges; and
sending, to the mobile device, the computed reduced local map.

2. The method according to claim 1, further comprising:
obtaining auxiliary data for predicting the position of the mobile device; and
wherein the predicting a position comprises predicting the position of the mobile device based on the auxiliary data.

3. The method according to claim 2, wherein the auxiliary data comprises a current position of the mobile device.

4. The method according to claim 2, wherein the auxiliary data comprises a current movement indicator of the mobile device.

5. The method according to claim 2, wherein the auxiliary data comprises an indication of the time it takes for the server to compute the reduced local map.

6. The method according to claim 2, wherein the auxiliary data comprises an indication of the time it takes for the server to send the reduced local map to the mobile device.

7. The method according to claim 1, further comprising:
estimating a field of view of the mobile device; and
wherein the computing the reduced local map comprises computing the reduced local map for the mobile device such that vertices of the global map that are within the estimated field of view are more likely to form part of the reduced local map than vertices outside the estimated field of view.

8. The method according to claim 7, wherein the computing the reduced local map comprises including all vertices of the global map that are within the estimated field of view and that are within a distance threshold from the mobile device.

9. The method according to claim 1, wherein the predicting a position of the mobile device and computing a reduced local map are performed a plurality of times, respectively, for a plurality of scenarios, resulting in a plurality of reduced local maps.

10. The method according to claim 9, wherein the sending the computed reduced local map comprises sending the plurality of reduced local maps.

11. The method according to claim 9, further comprising:
receiving, after the receiving the first measurements, second measurements from the mobile device indicating an updated pose of the mobile device, the updated pose being associated with a later time than a pose corresponding to the first measurements; and
discarding at least one of the plurality of reduced local maps based on the updated pose.

12. The method according to claim 1, wherein the measurements are based on at least one of inertial measurements, LIDAR measurements, two-dimensional images, three-dimensional images and radar measurements.

13. The method according to claim 1, wherein each vertex represents a pose of the mobile device or a feature observed by the mobile device.

14. A server for updating a map for simultaneous localisation and mapping, SLAM, the server comprising:
a processor; and
a memory storing instructions that, when executed by the processor, cause the server to:
receive first measurements from a mobile device, the first measurements being collected using at least one sensor of the mobile device;
determine that a new reduced local map is to be computed for the mobile device;
predict a position of the mobile device, corresponding to where the mobile device is likely to be located at a time when a future reduced local map is available in the mobile device;
compute a reduced local map for the mobile device based on the predicted position, the reduced local map being a subset of a global map, wherein the global map is in the form of a graph comprising vertices and edges; and
send, to the mobile device, the computed reduced local map.

15. The server according to claim 14, further comprising instructions that, when executed by the processor, cause the server to:
obtain auxiliary data for predicting the position of the mobile device; and
wherein the instructions to predict a position comprise instructions that, when executed by the processor, cause the server to predict the position of the mobile device based on the auxiliary data.

16. The server according to claim 15, wherein the auxiliary data comprises a current position of the mobile device.

17. The server according to claim 15, wherein the auxiliary data comprises a current movement indicator of the mobile device.

18. The server according to claim 15, wherein the auxiliary data comprises an indication of the time it takes for the server to compute the reduced local map.

19. The server according to claim 15, wherein the auxiliary data comprises an indication of the time it takes for the server to send the reduced local map to the mobile device.

20. The server according to claim 14, further comprising instructions that, when executed by the processor, cause the server to:
estimate a field of view of the mobile device; and
wherein the instructions to compute the reduced local map comprise instructions that, when executed by the processor, cause the server to compute the reduced local map for the mobile device such that vertices of the global map that are within the estimated field of view are more likely to form part of the reduced local map than vertices outside the estimated field of view.

21. The server according to claim 20, wherein the instructions to compute the reduced local map comprise instructions that, when executed by the processor, cause the server to include all vertices of the global map that are within the estimated field of view and that are within a distance threshold from the mobile device.

22-24. (canceled)

25. The server according to claim 14, wherein the measurements are based on at least one of inertial measurements, LIDAR measurements, two-dimensional images, three-dimensional images and radar measurements.

26. The server according to claim 14, wherein each vertex represents a pose of the mobile device or a feature observed by the mobile device.

27. A computer program product comprising a computer and a computer readable means comprising non-transitory memory in which the computer program is stored, wherein the computer program is for updating a map for simultaneous localisation and mapping, SLAM, the computer program comprising computer program code which, when executed on a server causes the server to:
receive first measurements from a mobile device, the first measurements being collected using at least one sensor of the mobile device;
determine that a new reduced local map is to be computed for the mobile device;
predict a position of the mobile device, corresponding to where the mobile device is likely to be located at a time when a future reduced local map is available in the mobile device;
compute a reduced local map for the mobile device based on the predicted position, the reduced local map being a subset of a global map, wherein the global map is in the form of a graph comprising vertices and edges; and
send, to the mobile device, the computed reduced local map.

28. (canceled)
